(19) United States
(12) Patent Application Publication
(10) Pub. No.: US 2024/0403652 A1
(43) Pub. Date: Dec. 5, 2024

(54) HIERARCHICAL LATENT MIXTURE POLICIES FOR AGENT CONTROL

(71) Applicant: DeepMind Technologies Limited, London (GB)

(72) Inventors: Dushyant ` Rao, London (GB); Fereshteh Sadeghi, San Jose, CA (US); Leonard Hasenclever, London (GB); Markus Wulfmeier, London (GB); Martina Zambelli, London (GB); Giulia Vezzani, London (GB); Dhruva Tirumala Bukkapatnam, London (GB); Yusuf Aytar, London (GB); Joshua Merel, Chicago, IL (US); Nicolas Manfred Otto Heess, London (GB); Raia Thais Hadsell, London (GB)

(21) Appl. No.: 18/699,012

(22) PCT Filed: Oct. 5, 2022
(86) PCT No.: PCT/EP2022/077694

§ 371 Date: Apr. 5, 2024

Related U.S. Application Data
(60) Provisional application No. 63/252,582, filed on Oct. 5, 2021.

(51) Int. Cl. G06N 3/092

(52) U.S. Cl. CPC G06N 3/092

(57) ABSTRACT

Methods, systems, and apparatus, including computer programs encoded on a computer storage medium, for controlling agents. In particular, an agent can be controlled using a hierarchical controller that includes a high-level controller neural network, a mid-level controller neural network, and a low-level controller neural network.

### CROSS-REFERENCE TO RELATED APPLICATIONS

This application claims priority to U.S. Provisional Application Ser. No. 63/252,582 filed on Oct. 5, 2021, the disclosure of which is incorporated in its entirety into this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to attempt to perform a task in the environment using a hierarchical controller that includes a high-level controller neural network, a mid-level controller neural network, and a low-level controller neural network.

Particular embodiments of the subject matter described in this specification can be implemented so as to realize one or more of the following advantages.

The described techniques control an agent by exploiting a three-level hierarchy of both discrete and continuous latent variables, to capture a set of abstract high-level behaviours while allowing for variance in how they are executed. In particular, the system uses a model that includes a low-level latent-conditioned controller that can learn motor primitives, a set of continuous latent mid-level skills, and a discrete high-level controller that can compose and select among these abstract mid-level behaviours, allowing for effective control of the agent.

By training this model as described, the system can cause the model to effectively cluster offline data into distinct, executable behaviours, while retaining the flexibility of a continuous latent variable model. The resulting skills can be transferred and fine-tuned on new tasks, unseen objects, and from state to vision-based policies, yielding significantly better sample efficiency and asymptotic performance compared to existing skill- and imitation-based methods.

Additionally, the learned skills encourage directed exploration to cover large regions of the state space relevant to the task, resulting in the system being able to effectively control the agent even in challenging sparse-reward settings.

In one example described herein, a method for controlling an agent interacting with an environment to perform a task comprises, at each of a plurality of time steps: receiving an observation characterizing a state of the environment at the time step: processing a high-level input derived from the observation using a high-level controller neural network to generate a high-level output comprising a respective score for each skill in a set of skills: selecting, using the high-level output, a skill from the set of skills: processing a mid-level input derived from the observation using a mid-level controller neural network and while the mid-level controller neural network is conditioned on the selected skill to generate a latent action vector from a latent action space; and processing a low-level input derived from the observation and the latent action vector using a low-level controller neural network to generate a policy output that defines an action to be performed by the agent in response to the observation. Processing a high-level input derived from the observation using the high-level controller neural network to generate the high-level output comprising a respective score for each skill in a set of skills may comprise processing the high-level input using the high-level controller neural network while the high-level controller neural network is conditioned on a skill that was selected at a preceding time step. The high-level controller neural network may comprise a respective high-level neural network head for each skill in the set of skills. Processing the high-level input using the high-level controller neural network while the high-level controller neural network is conditioned on a skill that was selected at a preceding time step may comprise processing the high-level input using only the respective high-level neural network head corresponding to the skill that was selected at the preceding time step. The mid-level controller neural network may be configured to process the mid-level input to generate a mid-level output that comprises parameters of a distribution over the latent action space. Processing the mid-level input using the mid-level controller neural network may comprise sampling from the distribution over the latent action space parameterized by the mid-level output to generate the latent action vector. The mid-level controller neural network may comprises a respective mid-level neural network head for each skill in the set of skills. Processing a mid-level input derived from the observation using a mid-level controller neural network and while the mid-level controller neural network is conditioned on the selected skill to generate a latent action vector from a latent action space may comprise processing the mid-level input using only the respective mid-level neural network head corresponding to the selected skill that was selected at the time step. The low-level input may include different information from the observation at the time step from the mid-level and high-level inputs. The low-level input may include only proprioceptive information of the agent at the time step. The mid-level and/or high-level inputs may include additional information in addition to the proprioceptive information. The high-level input, the mid-level input, or both may include a visual observation of the environment at the time step while the low-level input does not include the visual observation of the environment. The high-level controller neural network and the mid-level controller neural network may have been trained through reinforcement learning on training data for the task. The low-level controller neural network may have been pre-trained and then frozen during the training of the high-level controller neural network and the mid-level controller neural network through reinforcement learning on the training data for the task. The low-level controller neural network may have been pre-trained jointly with a different high-level controller neural network that was configured to receive as input a different type of observation data than the high-level controller neural network. The low-level controller neural network may have been pre-trained jointly with a different mid-level controller neural network that was configured to receive as input a different type of observation data than the mid-level controller neural network. The high-level controller neural network may have been trained through reinforcement learning on training data for the task while the low-level controller neural network and the mid-level controller neural network may have been pre-trained and then frozen during the training of the high-level controller neural network through reinforcement learning on the training data for the task. The low-level controller neural network and the mid-level controller neural network may have been pre-trained jointly with a different high-level controller neural network that was configured to receive as input a different type of observation data than the high-level controller neural network. The different high-level controller neural network may have been configured, during the pre-training, to receive object state data, data from future time steps that are after the current time step, or both. The training of the different high-level controller neural network may have been regularized, during the pre-training, based on a divergence between high-level outputs generated by the different high-level controller neural network and a prior distribution over skills in the set of skills conditioned on a skill that was selected at the immediately preceding time step. The prior distribution may be learned during the pre-training. The pre-training may be performed on off-line data. In some examples, the off-line data may not include any reward data for the task. The agent may be a mechanical agent. The environment may be a real-world environment. The observations may include sensor data sensed by one or more sensors configured to sense the environment.

In another example described herein, a system comprises one or more computers; and one or more storage devices communicatively coupled to the one or more computers. The one or more storage devices store instructions that, when executed by the one or more computers, cause the one or more computers to perform the operations of any method described herein.

In another example described herein, one or more non-transitory computer storage media store instructions that when executed by one or more computers cause the one or more computers to perform the operations of any method described herein.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for selecting an action.

FIG. 3 shows example architectures of the high, mid, and low-level controller neural networks.

FIG. 4 is a flow diagram of an example process for training the high, mid, and low-level controller neural networks.

FIG. 5 shows the performance of the described techniques relative to conventional techniques.

Like reference numbers and designations in the various drawings indicate like elements.

### DETAILED DESCRIPTION

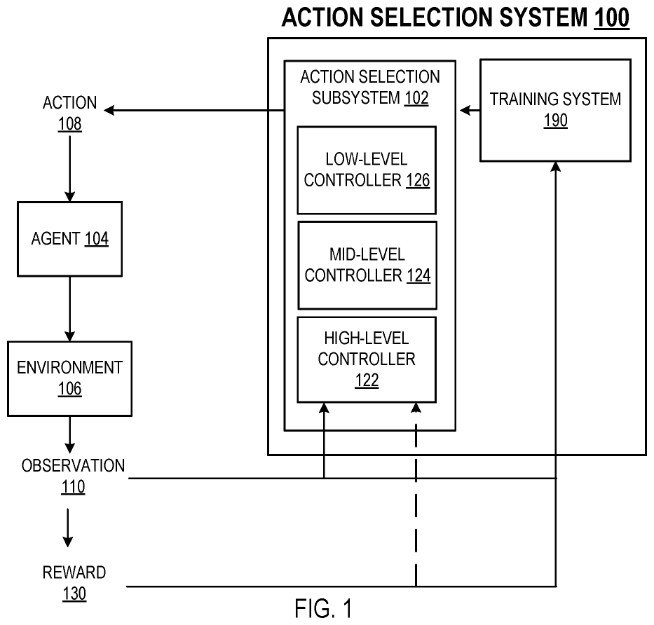

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As a general example, the task can include one or more of, e.g., navigating to a specified location in the environment, identifying a specific object in the environment, manipulating the specific object in a specified way, controlling items of equipment to satisfy criteria, distributing resources across devices, and so on. More generally, the task is specified by received rewards, i.e., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives a reward 130 from the environment 106.

Generally, the reward 130 is a scalar numerical value and characterizes the progress of the agent 104 towards completing the task.

As a particular example, the reward 130 can be a sparse binary reward that is zero unless the task is successfully completed as a result of the action being performed, i.e., is only non-zero, e.g., equal to one, if the task is successfully completed as a result of the action performed.

As another particular example, the reward 130 can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, at each time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step, the return can satisfy:

$${\sum }_{i} {γ}^{i - t - 1} {r}_{i} ,$$

where i ranges either over all of the time steps after t in the episode or for some fixed number of time steps after t within the episode, γ is a discount factor that is greater than zero and less than or equal to one, and rᵢ is the reward at time step i.

To control the agent, at each time step in the episode, an action selection subsystem 102 of the system 100 uses a high-level controller neural network 122, a mid-level controller neural network 124, and a low-level controller neural network 126 to select the action 108 that will be performed by the agent 104 at the time step.

In particular, the action selection subsystem 102 uses the controllers 122, 124, and 126 to process the observation 110 to generate a policy output and then uses the policy output to select the action 108 to be performed by the agent 104 at the time step.

In one example, the policy output may include a respective numerical probability value for each action in the fixed set. The system 102 can select the action, e.g., by sampling an action in accordance with the probability values for the action indices, or by selecting the action with the highest probability value.

In another example, the policy output may include a respective Q-value for each action in the fixed set. The system 102 can process the Q-values (e.g., using a soft-max function) to generate a respective probability value for each action, which can be used to select the action (as described earlier), or can select the action with the highest Q-value.

The Q-value for an action is an estimate of a return that would result from the agent performing the action in response to the current observation and thereafter selecting future actions performed by the agent in accordance with current values of the parameters of the controllers 122, 124, and 126.

As another example, when the action space is continuous, the policy output can include parameters of a probability distribution over the continuous action space and the system 102 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output can include a regressed action, i.e., a regressed vector representing an action from the continuous space, and the system 102 can select the regressed action as the action 108.

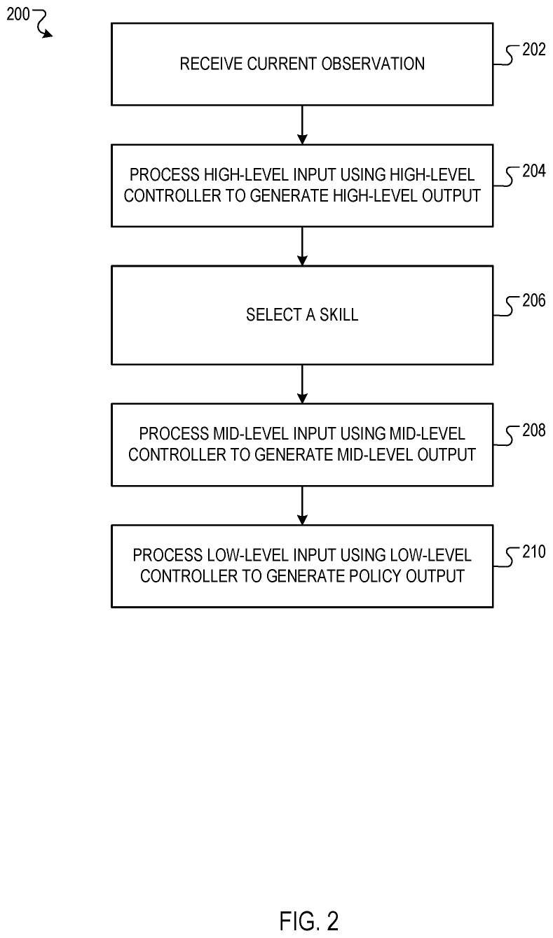

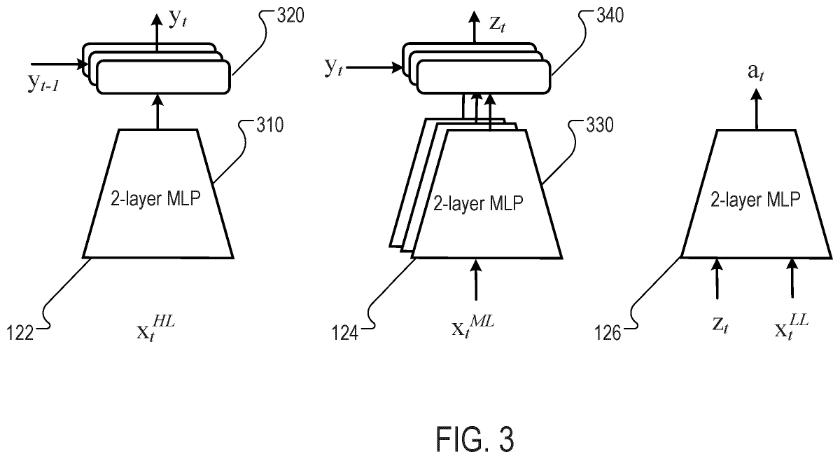

Controlling the agent at any given time step using the high-level controller 122, the mid-level controller 124, and the low-level controller 126 will be described in more detail below with reference to FIGS. 2 and 3.

Prior to using the controllers 122, 124, and 126 to control the agent, a training system 190 within the system 100 or another training system can train the controllers 122, 124, and 126.

In particular, the training system 190 can first jointly train an original high-level controller, an original mid-level controller, and an original low-level controller on offline data.

The system 190 can then replace the original high-level controller with the high-level controller 122 while keeping the original low-level controller frozen, i.e., so that the low-level controller 126 is the same as the original low-level controller. The system 190 can then train the high-level controller 122 through reinforcement learning on the rewards 130 for the task.

In some implementations, the system 190 also replaces the original mid-level controller with the mid-level controller 124 and trains the mid-level controller 124 along with the high-level controller 122 while, in some other implementations, the original mid-level controller is also kept frozen.

Keeping a neural network “frozen” during training refers to not changing the values of the parameters of the neural network, i.e., keeping the parameter values fixed while changing the parameter values of another neural network.

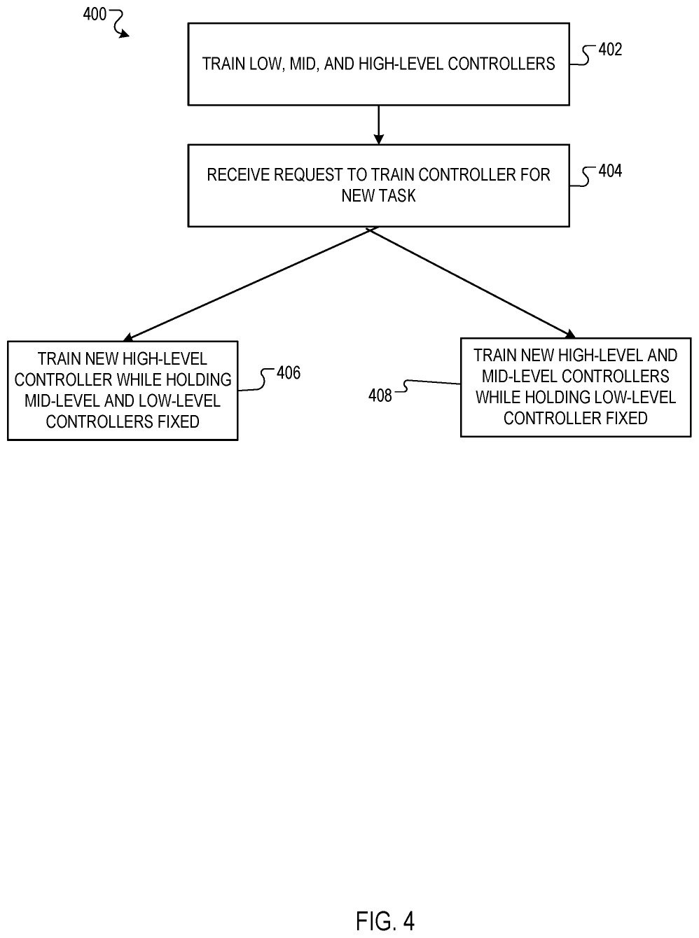

Training is described in more detail below with reference to FIG. 4.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing environment may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment. e.g. sensors sensing a state or configuration of the manufacturing units or machines, or sensors sensing movement of material between the manufacturing units or machines. As some examples such sensors may be configured to sense mechanical movement or force, pressure, temperature: electrical conditions such as current, voltage, frequency, impedance: quantity, level, flow/movement rate or flow/movement path of one or more materials: physical or chemical conditions e.g. a physical state, shape or configuration or a chemical state such as pH: configurations of the units or machines such as the mechanical configuration of a unit or machine, or valve configurations: image or video sensors to capture image or video observations of the manufacturing units or of the machines or movement: or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below: These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy: a temperature of the facility: fluid flow, temperature or pressure within the facility or within a cooling system of the facility: or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility. e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy: temperature or cooling of the physical environment: fluid flow: or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug. for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity. e.g. as computer executable instructions: an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment. e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2 is a flow diagram of an example process 200 for selecting an action. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system can perform the process 200 at each time step during a sequence of time steps, e.g., at each time step during a task episode. The system continues performing the process 200 until termination criteria for the episode are satisfied, e.g., until the task has been successfully performed, until the environment reaches a designated termination state, or until a maximum number of time steps have elapsed during the episode.

The system receives an observation characterizing a state of the environment at the time step (step 202).

The system processes a high-level input derived from the observation using the high-level controller neural network to generate a high-level output that includes a respective score for each skill in a set of skills (step 204), i.e., in a discrete set of latent skills.

The system selects, using the skill output, a skill from the set of skills (step 206). That is, the system can select the skill with the highest score or sample a skill from the set in accordance with the scores. Because of the way that that the mid-level and low-level controllers are trained, selecting different skills will cause the agent to perform different high-level behaviors. Thus, the high-level controller generates outputs that control which high-level behavior the agent will perform at any given time step.

The system processes a mid-level input derived from the observation using the mid-level controller neural network and while the mid-level controller neural network is conditioned on the selected skill to generate a latent action vector from a latent action space (step 208).

In some implementations, the mid-level controller neural network directly regresses the latent action vector.

In some other implementations, the mid-level controller neural network generates a mid-level output that includes parameters of a distribution over the latent action space, and, as part of processing the mid-level input using the mid-level controller neural network, the system samples from the distribution over the latent action space parameterized by the mid-level output to generate the latent action vector. For example, the mid-level output can be the parameters of a multi-variate Gaussian distribution over the latent action space.

In some implementations, the mid-level controller neural network directly receives both the mid-level input and the selected skill as input.

In some other implementations, the mid-level controller includes a respective “head” for each skill and generates the latent action vector using the head corresponding to the selected skill and not using any of the other heads corresponding to any of the other skills. An example of this is shown below with reference to FIG. 3.

Thus, by making use of the mid-level controller, the system uses a discrete skill to generate a continuous latent action vector. Generating the latent action vector in this manner allows the system to capture discrete skills, but allow for latent variation in how the discrete are executed, as represented by the latent action vector. This can allow the system to effectively perform difficult tasks, e.g., robotic tasks that require manipulating difficult objects. That is, the system can model both discrete modes and continuous variation in behavior, allowing for effective control in difficult settings.

The system processes a low-level input derived from the observation and the latent action vector using the low-level controller neural network to generate a policy output that defines an action to be performed by the agent in response to the observation (step 210). Examples of policy outputs are described above with reference to FIG. 1.

The system then selects an action using the policy output and causes the agent to perform the selected action, e.g., by directly submitting a control input to the agent or by transmitting instructions or other data to a control system for the agent that will cause the agent to perform the selected agent.

In some implementations, the high-level, mid-level, and low-level inputs are the same, i.e., each input includes all of the data in the observation received by the system.

In some other implementations, the system makes use of information asymmetry between the controllers. In particular, the low-level input can include different information from the observation at the time step from the mid-level and high-level inputs and, optionally, the mid-level input can include different information from the high-level input.

For example, the high-level and mid-level inputs can include additional context, task-specific information, or both that is included in the observation but that is not provided as part of the low-level input. This can ensure that the high-level remains responsible for abstract, task-related behaviours, while the low-level executes simpler motor primitives.

Some examples of information asymmetry that can be employed by the system follow.

As one example, when the agent is a robot or other mechanical agent, the observation can include proprioceptive information captured by one or more sensors of the agent. In this example, the low-level input can include only proprioceptive information of the agent at the time step and the mid-level and high-level inputs can include additional information in addition to the proprioceptive information.

As another example, the observation can include a visual observation of the environment, e.g., one or more camera images captured by a camera sensor of the agent, a camera sensor mounted elsewhere in the environment, or both. In this example, the high-level input, the mid-level input, or both can include the visual observation of the environment at the time step and the low-level input does not include the visual observation of the environment.

As a particular example, both the high-level and the mid-level inputs can include both the visual observation and the proprioceptive information while the low-level input can include only the proprioceptive information.

As another example, the agent may comprise a collection of co-operating robots or mechanical agents. In this case, the low-level input may include proprioceptive information of a single agent (or unit of agents), while the mid-level and high-level inputs can include proprioceptive information relating to other agents (or units of agents).

As another example, where the environment is a service facility such as a server farm or data center, the observation includes electronic signals representing the functioning of the facility or of equipment in the facility. In this example, a low-level input can include observations relating to a first subset of items of equipment in the facility, for example, one item of equipment. The mid-level input can include observations relating to a second subset (e.g. larger than the first subset) of items of equipment in the facility and the high-level input can include observations relating to a third subset of items of equipment in the facility (for example all equipment in the facility). The observations may include additional contextual information such as environmental or weather information, such as observations or forecasts, maintenance schedules or predicted demand. The mid-level and/or high-level inputs may include some or all of the additional contextual information.

FIG. 3 shows examples of the high, mid, and low-level controllers 122, 124, and 126.

As can be seen from FIG. 3, at a time step/during a task episode, the high-level controller neural network 122 is configured to process a high-level input xₜ^{HL} to generate a high-level output that includes a respective score for each skill in a set of skills. The system can then select, using the high-level output, a skill yₜ from the set of skills.

More specifically, the system processes the high-level input xₜ^{HL} using the high-level controller neural network 122 while the high-level controller neural network is conditioned on a skill yₜ₋₁ that was selected at a preceding time step t−1. Conditioning the high-level controller on the skill from the preceding time step can help ensure that the high-level controller generates output that cause temporally consistent high-level behavior.

In particular, in the example of FIG. 3, the high-level controller neural network 122 has a respective high-level neural network head 320 for each skill in the set of skills, and the system performs the conditioning by processing the high-level input xₜ^{HL} using only the respective high-level neural network head 320 corresponding to the skill yₜ₋₁ that was selected at the preceding time step. The heads 320 can generally have any appropriate neural network architecture. For example, each head 320 can be a multi-layer perceptron (MLP) or can each include a single fully-connected layer with a softmax activation.

That is, the high-level controller neural network 122 has a high-level encoder 310 that is shared among the skills and a respective high-level neural network head 320 for each skill in the set of skills. To process the high-level input xₜ^{HL} using only the respective high-level neural network head 320, the high-level controller neural network 122 processes the high-level input xₜ^{HL} using the encoder 310 and then processes the output of the encoder using only the respective high-level neural network head 320 corresponding to the skill yₜ₋₁ that was selected at the preceding time step to generate the high-level output.

The architecture of the encoder 310 is dependent on the type of information included in the high-level input. For example, in the example of FIG. 3, the high-level input includes low-dimensional data, e.g., state data like proprioceptive information or electrical conditions and the encoder 310 is therefore an MLP. When the high-level input includes higher-dimensional data, e.g., images or environmental conditions, the encoder 310 can include an MLP to encode the low-dimensional data and a convolutional neural network, a self-attention neural network or a neural network that includes both convolutional and self-attention layers to include the higher-dimensional data.

The mid-level controller neural network 124 is configured to process the mid-level input xₜ^{ML} while conditioned on the selected skill yₜ to generate a latent action vector zₜ from a latent action space. For example, the network 124 can generate a mid-level output that includes parameters of a distribution over the latent action space and then sample the latent action vector from the distribution.

In particular, in the example of FIG. 3, the mid-level controller neural network 124 has a respective mid-level neural network head 340 for each skill in the set of skills, and the system performs the conditioning by processing the mid-level input xₜ^{ML} using only the respective mid-level neural network head 340 corresponding to the skill yₜ. The heads 340 can generally have any appropriate neural network architecture. For example, the heads 340 can each be MLPs or can each include a single linear or non-linear layer.

That is, the mid-level controller neural network 124 has a mid-level encoder 330 that is shared among the skills and a respective mid-level neural network head 340 for each skill in the set of skills. To process the mid-level input xₜ^{ML} using only the respective mid-level neural network head 330 for the selected skill, the mid-level controller neural network 124 processes the mid-level input xₜ^{ML} using the encoder 330 and then processes the output of the encoder using only the respective mid-level neural network head 340 corresponding to the skill yₜ to generate the latent action vector zₜ.

The architecture of the encoder 330 is dependent on the type of information included in the mid-level input. For example, in the example of FIG. 3, the mid-level input includes low-dimensional data, e.g., state data like proprioceptive information, and the encoder 330 is therefore an MLP. When the mid-level input includes higher-dimensional data, e.g., images, the encoder 330 can include an MLP to encode the low-dimensional data and a convolutional neural network, a self-attention neural network or a neural network that includes both convolutional and self-attention layers to encode the higher-dimensional data.

The low-level controller neural network 126 processes (i) a low-level input xₜ^{LL} derived from the observation and (ii) the latent action vector zₜ to generate a policy output that defines an action at to be performed by the agent in response to the observation. The architecture of the low-level controller neural network 126 is dependent on the type of information included in the low-level input. For example, in the example of FIG. 3, the low-level input includes low-dimensional data, e.g., state data like proprioceptive information, and the low-level controller neural network 126 is therefore an MLP. When the high-level input includes higher-dimensional data, e.g., images, the low-level controller neural network 126 can include an MLP to encode the low-dimensional data and a convolutional neural network, a self-attention neural network or a neural network that includes both convolutional and self-attention layers to encode the higher-dimensional data.

FIG. 4 is a flow diagram of an example process 400 for training the high, mid, and low-level controller neural networks to perform a new task. For convenience, the process 400 will be described as being performed by a system of one or more computers located in one or more locations. For example, a training system, e.g., the training system 100 of FIG. 1, appropriately programmed, can perform the process 400.

The system pre-trains an original high-level controller neural network, an original mid-level controller neural network, and an original low-level controller neural network (step 402).

In particular, the system can perform this pre-training offline, i.e., without controlling the agent using the original high-level controller neural network, the original mid-level controller neural network, and the original low-level controller neural network, on an offline training data set.

For example, the offline dataset can include a set of a trajectories, each trajectory being a sequence of state-action pairs, that were collected as a result of the interaction of the agent with the environment while controlled using a different policy, e.g., a fixed control policy, an already-learned policy, or controlled by an expert, e.g., by a human user.

Thus, the system does not need access to and does not use any rewards for the new task during the pre-training.

As a particular example, during the pre-training, the system can train the original high-level, mid-level, and low-level controllers to minimize the Evidence Lower Bound (ELBO) for the state-conditional action distribution generated using the controllers. In particular, for a trajectory {x_{1:T}, a_{1:T}} that includes a respective state-action pair (xₜ, aₜ) aₜ each time step t from 1 to T, the ELBO can satisfy:

$${\sum }_{t = 1}^{T} [ {\sum }_{{y}_{t}} q ( {y}_{t} \vert {x}_{1 : t} ) ( log {p}_{{φ}_{a}} ( {a}_{t} \vert {\tilde{z}}_{t}^{\{ {y}_{t} \}} , {x}_{t} ) - {β}_{z} KL ( {q}_{{φ}_{z}} ( {z}_{t} \vert {y}_{t} , {x}_{t} ) \vert \vert p ( {z}_{t} \vert {y}_{t} ) ) ) ] -- {β}_{y} {\sum }_{t = 1}^{T} [ {\sum }_{{y}_{t - 1}} q ( {y}_{t - 1} \vert {x}_{1 : t - 1} ) KL ( {q}_{{φ}_{y}} ( {y}_{t} \vert {y}_{t - 1} , {x}_{t} ) \vert \vert {p}_{{φ}_{y}} ( {y}_{t} \vert {y}_{t - 1} ) ) ,$$

where \tilde{z}ₜ^{[y}^{_{t]}}˜q(zₜ|yₜ, xₜ). β_{z} and β_{y} are fixed constant values, and q(yₜ|yₜ, x_{1:t}) is a cumulative component probability that can be computed iteratively as Σ_{y}_{_{t−1}}q_{φ}_{_{y}}(yₜ|yₜ₋₁, xₜ)q(yₜ₋₁|x_{1:t-1}), p(zₜ|yₜ) is a prior distribution, e.g., the normal distribution, and p(y₀) is a fixed prior distribution, e.g., the uniform distribution, p_{φ}_{ₐ} represents the low-level controller, q_{φ}_{_{y}} represents the high-level controller, and q_{φ}_{_{z}} represents the low-level controller.

Thus, as can be seen from the ELBO, the training of the original high-level controller neural network is regularized based on a divergence between high-level outputs generated by the original high-level controller neural network q_{φ}_{_{y}}(yₜ|yₜ₋₁, zₜ) and a prior distribution p_{φ}_{_{y}}(yₜ|yₜ₋₁) over skills in the set of skills conditioned on a skill that was selected at the immediately preceding time step.

In some implementations, this prior distribution is fixed prior to training.

In some other implementations, however, the prior distribution is learned during the training. For example, the prior distribution can be modeled using a machine learning model, e.g., a linear softmax layer, that receives as input a one-hot representation of yₜ₋₁ and generates as output a probability distribution over the skills.

In some implementations, during this pre-training, the original high-level controller neural network can receive high-level inputs that include privileged information, i.e., information that is not available when performing inference for the new task. That is, because the pre-training is performed on off-line data and because, as will be described below, the original high-level controller neural network will not be used when performing inference for the new task, the system can provide high-level inputs that include privileged information to improve the effectiveness of the pre-trained original mid-level and low-level controllers.

As one example, during the pre-training, the original high-level controller neural network can be configured to receive object state data, i.e., data that, at any given time step, characterizes the states of objects in the vicinity of the agent at the time step. For example, the object state data can characterize the pose of the object, the distance of the object from the agent, or both.

As another example, during the pre-training, the original high-level controller neural network can be configured to, at any given time step, receive data from future time steps that are after the given time step. For example, the original high-level controller neural network can be configured to receive object state data, agent state data, or both at a threshold number of future time steps.

Optionally, the mid-level controller can also receive privileged information, e.g., the same as the high-level controller or a proper subset of the privileged information received by the high-level controller.

The system receives a request to train a controller neural network system for a new task (step 404).

In some implementations, in response to the request, the system trains a new high-level controller neural network through reinforcement learning on training data for the new task while keeping the original low-level controller neural network and the original mid-level controller neural network frozen (step 406).

That is, after this training, the high-level controller neural network has been trained through reinforcement learning on training data for the new task while the low-level controller neural network and the mid-level controller neural network have been pre-trained and were frozen during the training of the high-level controller on the training data for the new task.

Generally, during this training, the new high-level controller neural network does not receive any privileged information.

Moreover, in some implementations, the original high-level controller neural network is configured to receive as input a different type of observation data than the high-level controller neural network. That is, the described training scheme can generalize to new tasks that require processing different types of observations than are present in the offline data used for the pre-training. For example, the original high-level controller may have received low-dimensional state data while the new high-level controller receives inputs that include visual observations.

Generally, the system trains the high-level controller neural network to maximize expected returns received when the agent is controlled using the new high-level controller neural network and the frozen original mid and low-level controller neural networks.

Optionally, the system can modify the RL objective to depend not only on the expected returns but also on a regularization term that regularizes the score distributions π generated by the new high-level controller neural network relative to some prior distribution π₀. For example, the prior can be the previously learned transition prior or a fixed prior, e.g., the uniform categorical prior to encourage diversity in selected skills. As a particular example, the objective can satisfy:

$${\sum }_{t} {γ}^{t} ( {r}_{t} - {η}_{y} KL ( π ( {y}_{t} \vert {x}_{t} ) \vert \vert {π}_{0} ( {y}_{t} \vert {x}_{t} ) )$$

In some other implementations, in response to the request, the system trains a new high-level controller neural network and a new mid-level controller neural network through reinforcement learning on training data for the new task while holding the low-level controller neural network frozen (step 408). That is, after this training, the new high-level controller neural network and the new mid-level controller neural network have been trained through reinforcement learning on training data for the task while the original low-level controller neural network has been pre-trained and was frozen during the training of the high-level controller and the mid-level controller.

Training a new mid-level controller in addition to a new high-level controller can afford a more flexible transfer of the policies learned during the pre-training to the new task. Moreover, training a new mid-level controller can be required when the state data in the mid-level inputs during the pre-training is not available for the new task.

Generally, during this training, the new high-level controller neural network and the new mid-level controller neural networks do not receive any privileged information.

Moreover, in some implementations, the original high-level controller neural network is configured to receive as input a different type of observation data than the new high-level controller neural network, the original mid-level controller neural network is configured to receive as input a different type of observation data than the new mid-level controller neural network, or both. That is, the described training scheme can generalize to new tasks that require processing different types of observations than are present in the offline data used for the pre-training. For example, the original high-level controller and the original mid-level controller may have received low-dimensional state data while the new high and mid-level controllers receive inputs that include visual observations.

Generally, the system trains the new high-level controller neural network and the new mid-level controller neural network to maximize expected returns received when the agent is controlled using the new high-level and mid-level controller neural networks and the frozen original low-level controller neural network.

Optionally, the system can modify the RL objective to depend not only on the expected returns but also on a first regularization term that regularizes the score distributions π generated by the new high-level controller neural network relative to some prior distribution π₀, on a second regularization term that regularizes the latent action vectors π generated by the new mid-level controller neural network relative to some prior distribution π₀, or both.

As a particular example, the objective can satisfy:

$${\sum }_{t} {γ}^{t} ( {r}_{t} - {η}_{y} KL ( π ( {y}_{t} \vert {x}_{t} ) \vert \vert {π}_{0} ( {y}_{t} \vert {x}_{t} ) ) - {η}_{Z} {\sum }_{{y}_{t}} KL ( π ( {z}_{t} \vert {y}_{t} , {x}_{t} ) \vert \vert {π}_{0} ( {z}_{t} \vert {y}_{t} , {x}_{t} ) )$$

The prior distribution π₀(zₜ|yₜ, xₜ) can be, e.g., the distribution generated by the pre-trained original mid-level controller neural network or an appropriate different prior distribution. The system can use any appropriate reinforcement learning technique for performing steps 406 or 408. As a particular example, the system can perform step 406 using the MPO algorithm. As another particular example, the system can perform step 408 using the RHPO algorithm.

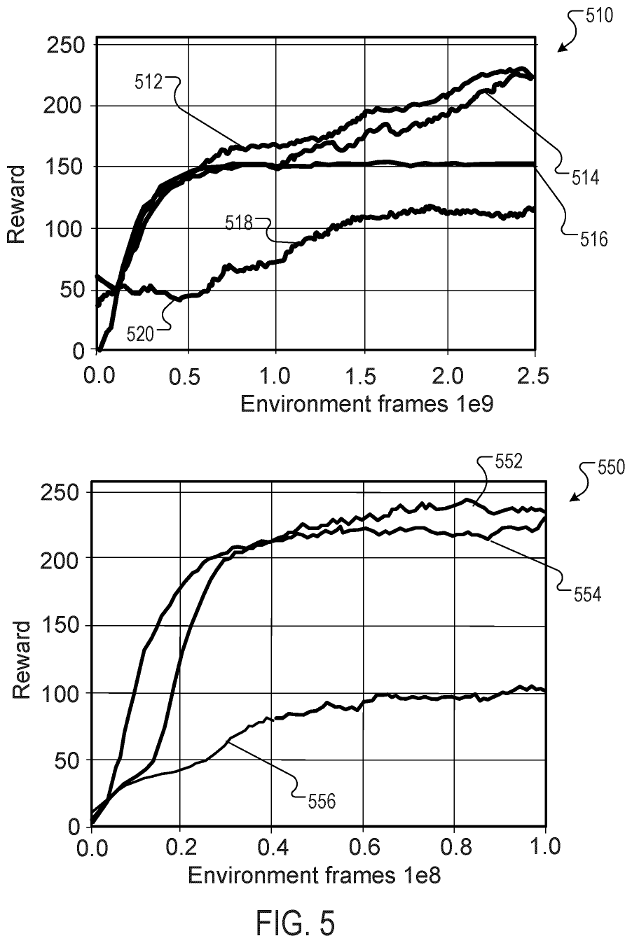

FIG. 5 shows the performance of the described techniques relative to conventional techniques for several tasks.

In particular, FIG. 5 shows two plots 510 and 550.

Plot 510 shows the performance of the described techniques relative to conventional techniques on a pyramid stacking task that requires a robot to stack objects in specified order to form a pyramid. In particular, plot 510 shows the performance of two variants of the described techniques 512 and 514 relative to two conventional techniques 516 and 518.

As can be seen from FIG. 5, the described techniques achieve a greater reward at a wide range of environment frames (time steps).

Plot 550 shows the performance of the described techniques relative to conventional techniques on a vision-based stacking task that requires a robot to stack objects based on visual observations. In particular, plot 550 shows the performance of one variant 552 of the described techniques relative to two conventional techniques 554 and 556.

As can be seen from FIG. 5, the described techniques are more sample-efficient while achieving a better asymptotic reward.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs. i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A method for controlling an agent interacting with an environment to perform a task, the method comprising, at each of a plurality of time steps:
receiving an observation characterizing a state of the environment at the time step;
processing a high-level input derived from the observation using a high-level controller neural network to generate a high-level output comprising a respective score for each skill in a set of skills;
selecting, using the high-level output, a skill from the set of skills;
processing a mid-level input derived from the observation using a mid-level controller neural network and while the mid-level controller neural network is conditioned on the selected skill to generate a latent action vector from a latent action space; and
processing a low-level input derived from the observation and the latent action vector using a low-level controller neural network to generate a policy output that defines an action to be performed by the agent in response to the observation.

2. The method of claim 1, wherein processing a high-level input derived from the observation using the high-level controller neural network to generate the high-level output comprising a respective score for each skill in a set of skills comprises:
processing the high-level input using the high-level controller neural network while the high-level controller neural network is conditioned on a skill that was selected at a preceding time step.

3. The method of claim 2, wherein the high-level controller neural network comprises a respective high-level neural network head for each skill in the set of skills, and wherein processing the high-level input using the high-level controller neural network while the high-level controller neural network is conditioned on a skill that was selected at a preceding time step comprises:
processing the high-level input using only the respective high-level neural network head corresponding to the skill that was selected at the preceding time step.

4. The method of claim 1, wherein the mid-level controller neural network is configured to process the mid-level input to generate a mid-level output that comprises parameters of a distribution over the latent action space, and wherein processing the mid-level input using the mid-level controller neural network comprises:
sampling from the distribution over the latent action space parameterized by the mid-level output to generate the latent action vector.

5. The method of claim 1, wherein the mid-level controller neural network comprises a respective mid-level neural network head for each skill in the set of skills, and wherein processing a mid-level input derived from the observation using a mid-level controller neural network and while the mid-level controller neural network is conditioned on the selected skill to generate a latent action vector from a latent action space comprises:
processing the mid-level input using only the respective mid-level neural network head corresponding to the selected skill that was selected at the time step.

6. The method of claim 1, wherein the low-level input includes different information from the observation at the time step from the mid-level and high-level inputs.

7. The method of claim 6, wherein the low-level input includes only proprioceptive information of the agent at the time step and the mid-level and high-level inputs include additional information in addition to the proprioceptive information.

8. The method of claim 6, wherein the high-level input, the mid-level input, or both include a visual observation of the environment at the time step and the low-level input does not include the visual observation of the environment.

9. The method of claim 1, wherein the high-level controller neural network and the mid-level controller neural network have been trained through reinforcement learning on training data for the task while the low-level controller neural network has been pre-trained and was frozen during the training of the high-level controller neural network and the mid-level controller neural network through reinforcement learning on the training data for the task.

10. The method of claim 9, wherein the low-level controller neural network was pre-trained jointly with a different high-level controller neural network that was configured to receive as input a different type of observation data than the high-level controller neural network and a different mid-level controller neural network that was configured to receive as input a different type of observation data than the mid-level controller neural network.

11. The method of claim 1, wherein the high-level controller neural network has been trained through reinforcement learning on training data for the task while the low-level controller neural network and the mid-level controller neural network have been pre-trained and were frozen during the training of the high-level controller neural network through reinforcement learning on the training data for the task.

12. The method of claim 11, wherein the low-level controller neural network and the mid-level controller neural network were pre-trained jointly with a different high-level controller neural network that was configured to receive as input a different type of observation data than the high-level controller neural network.

13. The method of claim 10, wherein, during the pre-training the different high-level controller neural network was configured to receive object state data, data from future time steps that are after the current time step, or both.

14. The method of claim 10, wherein, during the pre-training, the training of the different high-level controller neural network was regularized based on a divergence between high-level outputs generated by the different high-level controller neural network and a prior distribution over skills in the set of skills conditioned on a skill that was selected at the immediately preceding time step.

15. The method of claim 14, wherein the prior distribution is learned during the pre-training.

16. The method of claim 9, wherein the pre-training is performed on off-line data.

17. The method of claim 16, wherein the off-line data does not include any reward data for the task.

18. The method of claim 1, wherein the agent is a mechanical agent, the environment is a real-world environment, and the observations include sensor data sensed by one or more sensors configured to sense the environment.

19. A system comprising:
one or more computers; and
one or more storage devices communicatively coupled to the one or more computers, wherein the one or more storage devices store instructions that, when executed by the one or more computers, cause the one or more computers to perform operations for controlling an agent interacting with an environment to perform a task, the operations comprising, at each of a plurality of times steps:
receiving an observation characterizing a state of the environment at the time step;
processing a high-level input derived from the observation using a high-level controller neural network to generate a high-level output comprising a respective score for each skill in a set of skills,
selecting, using the high-level output, a skill from the set of skills;
process a mid-level input derived from the observation using a mid-level controller neural network and while the mid-level controller neural network is conditioned on the selected skill to generate a latent action vector from a latent action space, and
processing a low-level input derived from the observation and the latent action vector using a low-level controller neural network to generate a policy output that defines an action to be performed by the agent in response to the observation.

20. One or more non-transitory computer storage media storing instructions that when executed by one or more computers cause the one or more computers to perform operations for controlling an agent interacting with an environment to perform a task, the operations comprising, at each of a plurality of time steps:
receiving an observation characterizing a state of the environment at the time step,
processing a high-level input derived from the observation using a high-level controller neural network to generate a high-level output comprising respective score for each skill in a set of skills,
selecting, using the high-level output, a skill from the set of skills;
processing a mid-level input derived from the observation using a mid-level controller neural network and while the mid-level controller neural network is conditioned on the selected skill to generate a latent action vector from a latent action space, and
processing a low-level input derived from the observation and the latent action vector using a low-level controller neural network to generate a policy output that defines an action to be performed by the agent in response to the observation.
